(19) United States
(12) Patent Application Publication
(10) Pub. No.: US 2026/0210768 A1
(43) Pub. Date: Jul. 23, 2026

(54) FLUID TEMPERATURE FIELD TOMOGRAPHY VISUALIZATION DETECTION DEVICE

(71) Applicants: Tsinghua University, Beijing (CN); HON HAI PRECISION INDUSTRY CO., LTD., New Taipei (TW)

(72) Inventors: XIAN-LI CHEN, Beijing (CN); Peng Liu, Beijing (CN); Jia-Ping Wang, Beijing (CN); Shou-Shan Fan, Beijing (CN)

(21) Appl. No.: 19/442,054

(22) Filed: Jan. 7, 2026

(30) Foreign Application Priority Data
Jan. 23, 2025 (CN) 202510112845.8

(51) Int. Cl. G01J 5/48; G01J 5/00

(52) U.S. Cl. CPC G01J 5/485; G01J 5/0014; G01J 5/0037; G01J 2005/0077

(57) ABSTRACT

A fluid temperature field tomography visualization detection device comprises a planar temperature sensing element and an infrared thermal imager. The planar temperature sensing element comprises a suspended carbon nanotube layer for detecting a temperature of a fluid cross-section. The infrared thermal imager is spaced apart from the planar temperature sensing element. The infrared thermal imager is configured to detect an infrared signal of the carbon nanotube layer and image based on the infrared signal of the carbon nanotube layer.

### CROSS-REFERENCE TO RELATED APPLICATIONS

This application claims all benefits accruing under 35 U.S.C. § 119 from China Patent Application No. 202510112845.8, filed on Jan. 23, 2025, in the China National Intellectual Property Administration, the contents of which are hereby incorporated by reference.

### FIELD

The present disclosure relates to a fluid temperature field tomography visualization detection device, and particularly to a fluid temperature field tomography visualization detection device employing a carbon nanotube layer.

### BACKGROUND

In daily life and scientific research, it is often necessary to measure the temperature of fluids. In the prior art, thermometers are commonly used to measure temperature. Thermometers are easy to operate, low cost, and cad read temperature accurately. However, when using a thermometer to measure fluid temperature, the thermometer often can only measure the temperature of a local point, the response is slow, and it is unable to measure rapidly changing or large-area fluid temperature fields.

### BRIEF DESCRIPTION OF THE DRAWINGS

Implementations of the present technology will now be described, by way of example only, with reference to the attached FIG. s, wherein:

FIG. 1 is a schematic structural view of a fluid temperature field tomography visualization detection device according to a first embodiment of the present disclosure.

FIG. 2 is a scanning electron microscope (SEM) image of a carbon nanotube layer provided by an embodiment of the present disclosure.

FIG. 3 is an SEM image of a carbon nanotube wire provided by an embodiment of the present disclosure.

FIG. 4 is an SEM image of another carbon nanotube wire provided by an embodiment of the present disclosure.

FIG. 5 is a schematic structural view of the fluid temperature field tomography visualization detection device shown in FIG. 1, the fluid temperature field tomography visualization detection device is shown testing a longitudinal cross-sectional temperature field of an airflow.

FIG. 6 is a schematic structural view of the fluid temperature field tomography visualization detection device shown in FIG. 1, the fluid temperature field tomography visualization detection device is shown testing a transverse cross-sectional temperature field of an airflow.

FIG. 7 is an infrared image displayed by an infrared thermal imager when the a distance between the carbon nanotube layer and the outer diameter of an airflow nozzle is zero (0) mm, the fluid temperature field tomography visualization detection device is shown testing a longitudinal cross-sectional temperature of an airflow.

FIG. 8 is an infrared image displayed by an infrared thermal imager when the distance between the carbon nanotube layer and the outer diameter of the airflow nozzle is 1.5 mm, the fluid temperature field tomography visualization detection device is shown testing a longitudinal cross-sectional temperature of an airflow using the device of the present disclosure.

FIG. 9 is an infrared image displayed by an infrared thermal imager when the distance between the carbon nanotube layer and the outer diameter of the airflow nozzle is 3 mm, the fluid temperature field tomography visualization detection device is shown testing a longitudinal cross-sectional temperature of an airflow using the device of the present disclosure.

FIG. 10 shows infrared images of a plurality of longitudinal cross-sections displayed by the infrared thermal imager, the fluid temperature field tomography visualization detection device is shown testing of a longitudinal cross-sectional temperature of an airflow using the device of the present disclosure.

FIG. 11 is a simulated 3D temperature field image of an airflow according to an embodiment of the present disclosure.

FIG. 12 is a schematic structural view of a fluid temperature field tomography visualization detection device according to a second embodiment of the present disclosure

### DETAILED DESCRIPTION

The disclosure is illustrated by way of example and not by way of limitation in the FIG. s of the accompanying drawings in which like references indicate similar elements. It should be noted that references to “another,” “an,” or “one” embodiment in this disclosure are not necessarily to the same embodiment, and such references mean “at least one.”

It will be appreciated that for simplicity and clarity of illustration, where appropriate, reference numerals have been repeated among the different FIG. S to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to illustrate details and features of the present disclosure better.

Several definitions that apply throughout this disclosure will now be presented.

The term “substantially” is defined to be essentially conforming to the particular dimension, shape, or other feature which is described, such that the component need not be exactly or strictly conforming to such a feature. The term “comprise,” when utilized, means “comprise, but not necessarily limited to”; it specifically indicates open-ended inclusion or membership in the so-described combination, group, series, and the like. The term of “first”, “second” and the like, are only used for description purposes, and should not be understood as indicating or implying their relative importance or implying the number of indicated technical features. Thus, the features defined as “first”, “second” and the like expressly or implicitly comprise at least one of the features. The term of “multiple times” means at least two times, such as two times, three times, etc., unless otherwise expressly and specifically defined.

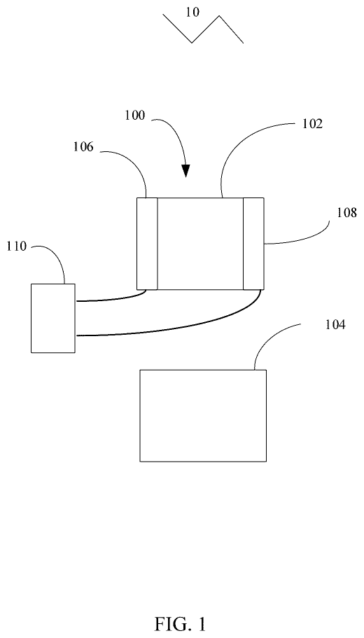

Referring to FIG. 1, an embodiment of the present disclosure provides a fluid temperature field tomography visualization detection device 10. The fluid temperature field tomography visualization detection device 10 comprises: a planar temperature sensing element 100, which is used to detect the temperature of a fluid cross-section, and comprises a suspended carbon nanotube layer 102; and an infrared thermal imager 104, which is spaced apart from the planar temperature sensing element 100, and is used to detect the infrared signal of the suspended portion of the carbon nanotube layer 102, and to create an image based on the infrared signal of the carbon nanotube layer 102.

The fluid can be a gas or a liquid. The specific gas or liquid to be tested is not limited, as long as it is ensured that the fluid to be tested is transparent in a specific infrared band and does not chemically react with the carbon nanotube material. In this embodiment, the fluid to be tested is a gas.

The planar temperature sensing element 100 further comprises a bracket (not shown), a first electrode 106, a second electrode 108, and a power supply 110. The first electrode 106 and the second electrode 108 are disposed at both ends of the carbon nanotube layer 102 and electrically connected to the carbon nanotube layer 102. The power supply 110 provides current to the carbon nanotube layer through the first electrode 106 and the second electrode 108. The carbon nanotube layer 102 is a self-supporting structure. Self-support means that the carbon nanotube layer 102 does not require a large area of carrier support, but can maintain its overall state by being suspended as long as support is provided on both sides. That is, when the carbon nanotube layer 102 is placed (or fixed) on two support frames set at a certain distance apart, the carbon nanotube layer 102 located between the two support frames can be suspended and maintain its overall state. The bracket is used to support the carbon nanotube layer 102 and can ensure that the carbon nanotube layer 102 is suspended. Preferably, the bracket only contacts the edge of the carbon nanotube layer 102. For example, the support can be a hollow frame or multiple spaced columns. In this embodiment, the support is a hollow frame.

The carbon nanotube layer 102 may comprise at least one carbon nanotube film. The at least one carbon nanotube film comprises a plurality of carbon nanotubes connected by van der Waals forces. The plurality of carbon nanotubes can be arranged in an ordered or disordered manner. The thickness of the carbon nanotube layer ranges from 1 nanometer to 100 micrometers. The at least one carbon nanotube film may be a thin film of super-aligned carbon nanotubes. The at least one carbon nanotube film may be a structure composed solely of carbon nanotubes. The at least one carbon nanotube film may comprise a single super-aligned carbon nanotube film or a plurality of super-aligned carbon nanotube films stacked on top of each other. When the carbon nanotube layer comprises a plurality of super-aligned carbon nanotube films, these plurality of super-aligned carbon nanotube films are stacked. The intersection angle between carbon nanotubes in adjacent super-aligned carbon nanotube films can be any angle, preferably 90 degrees, which makes the resulting carbon nanotube layer more stable and less prone to damage.

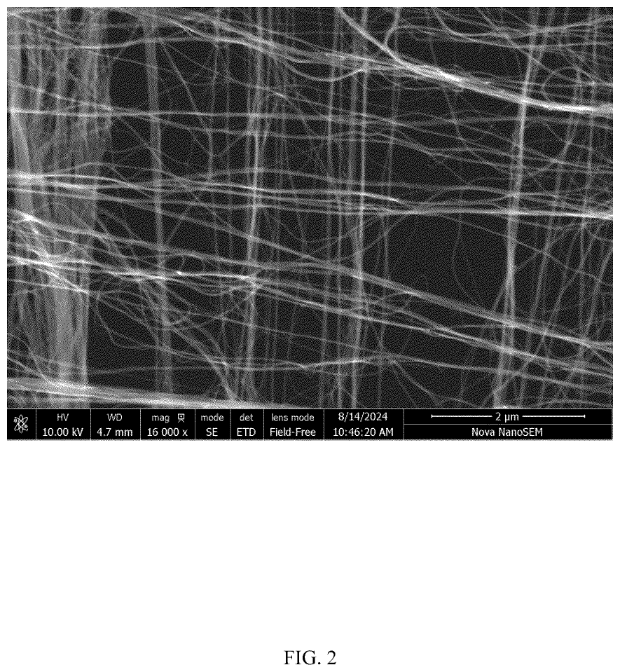

The super aligned carbon nanotube film is a carbon nanotube film obtained by pulling from a carbon nanotube array. Referring to FIG. 2, the super aligned carbon nanotube film comprises a plurality of carbon nanotubes preferentially oriented in the same direction and arranged parallel to the surface of the super aligned carbon nanotube film. The carbon nanotubes are connected end-to-end by van der Waals forces along their extension direction. Each super aligned carbon nanotube film comprises a plurality of continuous and oriented carbon nanotube segments. These plurality of carbon nanotube segments are connected end-to-end by van der Waals forces. Each carbon nanotube segment comprises a plurality of parallel carbon nanotubes, which are tightly connected by van der Waals forces. The carbon nanotube segments have arbitrary width, thickness, uniformity, and shape. The thickness of the super aligned carbon nanotube film is 1 nanometer to 100 micrometers.

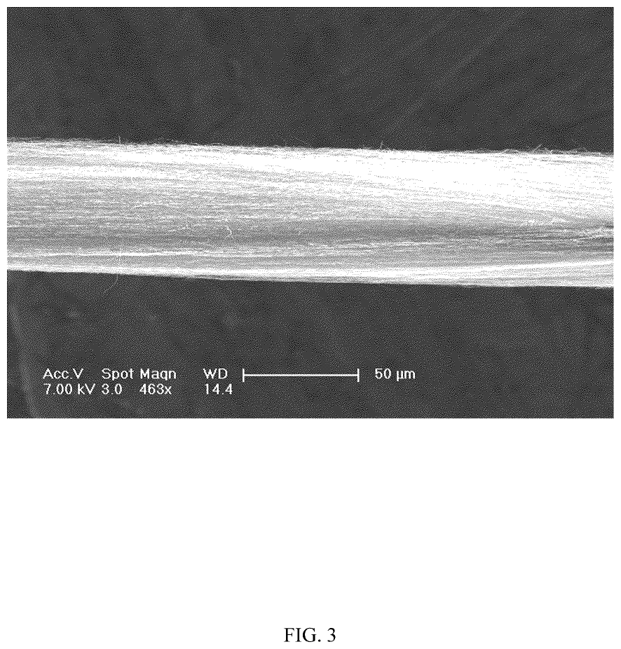

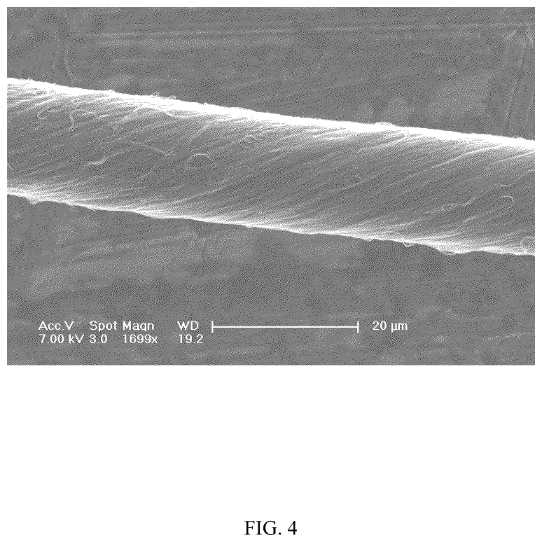

In another embodiment, the carbon nanotube layer 102 can also be a layered structure composed of a plurality of carbon nanotube wires. The plurality of carbon nanotube wires are arranged in parallel to form the carbon nanotube layer 102, or the plurality of carbon nanotube wires are woven together to form the carbon nanotube layer 102. Each carbon nanotube wire comprises a plurality of carbon nanotubes that extend along the axial direction of the carbon nanotube wire and are connected end-to-end. The extension direction of the plurality of carbon nanotubes can be parallel to the axial direction of the carbon nanotube wire, as shown in FIG. 3; or the plurality of carbon nanotubes can extend spirally along the axial direction of the carbon nanotube wire, as shown in FIG. 4. The diameter of each carbon nanotube wire is ranged from 10 nanometers to 100 micrometers. The carbon nanotube layer 102, woven from carbon nanotube wires, has higher strength and is less prone to breakage.

In this embodiment, the carbon nanotube layer 102 comprises two layers of vertically arranged super-aligned carbon nanotube films.

The first electrode 106, the second electrode 108, and the power supply 110 are used to provide electrical energy to the carbon nanotube layer 102, which can be heated by Joule heating. When there is a temperature difference between the carbon nanotube layer 102 and the fluid to be measured, it is not necessary to turn on the power supply. When the temperature of the carbon nanotube layer 102 is the same as or only slightly different from the temperature of the fluid being measured, changes in the fluid temperature and flow fields cannot be clearly observed. Therefore, it is necessary to turn on the power to heat the carbon nanotube layer 102, creating a suitable temperature difference between the carbon nanotube layer 102 and the fluid being measured. Alternatively, the fluid can be slightly heated while the carbon nanotube layer 102 remains unheated.

The infrared thermal imager 104 is spaced apart from the planar temperature sensing element 100. The infrared thermal imager 104 comprises a camera positioned directly facing the carbon nanotube layer 102. The infrared thermal imager 104 captures the infrared signal emitted from the surface of the carbon nanotube layer 102 through the camera. The infrared thermal imager 104 displays different colors depending on the strength of the infrared signal. The strength of the infrared signal emitted by the carbon nanotube layer 102 is related to the temperature of the fluid being measured. Because the thermal conductivity of the carbon nanotubes in the carbon nanotube layer 102 is between 0.1 and 0.2 W/m·K, the carbon nanotube layer 102 has a small heat capacity and can quickly respond to changes in the surrounding temperature. Therefore, when the planar temperature sensing element 100 is placed in the fluid to be measured, due to the temperature difference between the carbon nanotube layer 102 and the surrounding fluid, the carbon nanotube layer 102 is rapidly heated or cooled by the fluid. The temperature change on the surface of the carbon nanotube layer 102 emits an infrared signal, which is captured by an infrared thermal imager 104, which displays an infrared image of the surface of the carbon nanotube layer 102. Based on this infrared image, the specific temperature represented by the infrared image can be determined through comparative experiments. The infrared image represents the temperature of the surface of the carbon nanotube layer 102 and the temperature field distribution of the cross-section of the fluid to be measured within the carbon nanotube layer 102. The model and type of the infrared thermal imager 104 are not limited, as long as it can image the temperature distribution of the carbon nanotube layer 102.

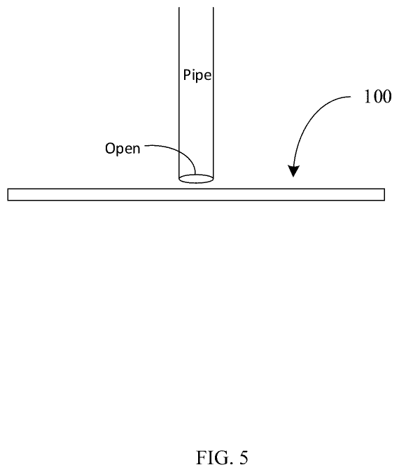

The fluid temperature field tomography visualization device 10 can detect a cross-sectional temperature field distribution of the airflow. Referring to FIG. 5, the fluid is ejected from a nozzle in a pipe, with the airflow direction perpendicular to the carbon nanotube layer 102. By adjusting the distance between the carbon nanotube layer 102 and the nozzle, the temperature field distribution of a plurality of cross-sections after the airflow exits the nozzle can be measured.

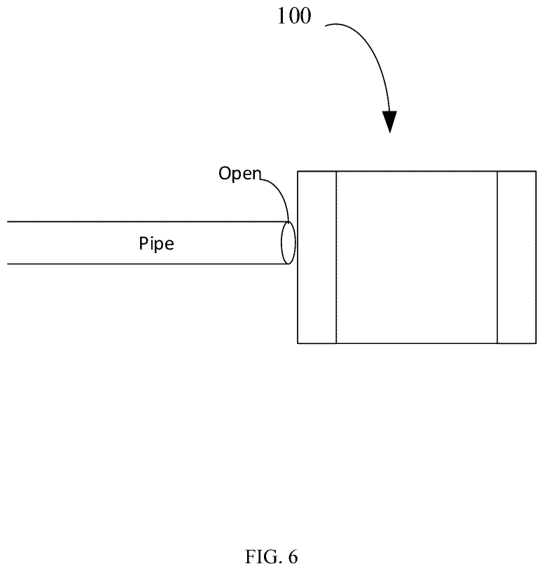

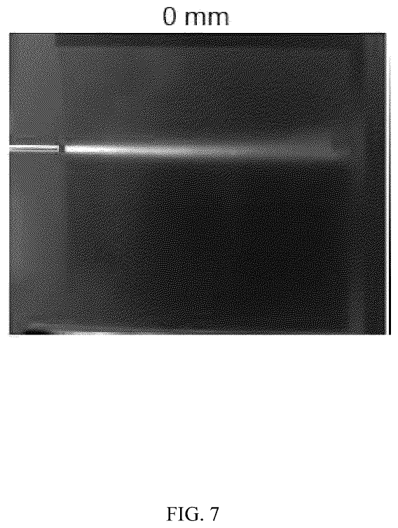

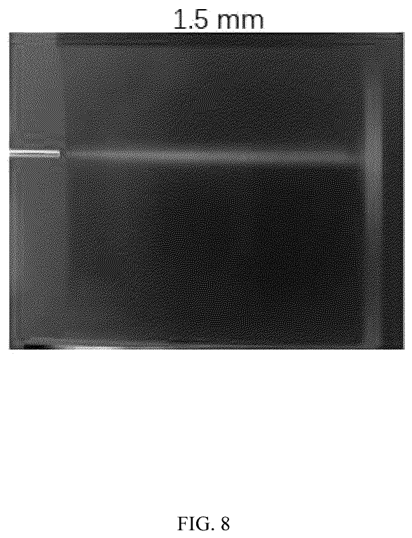

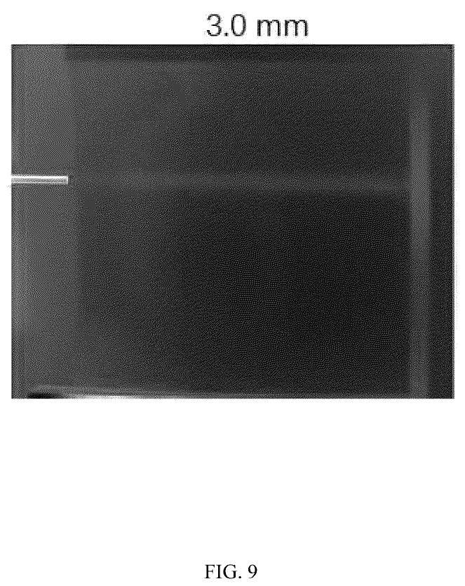

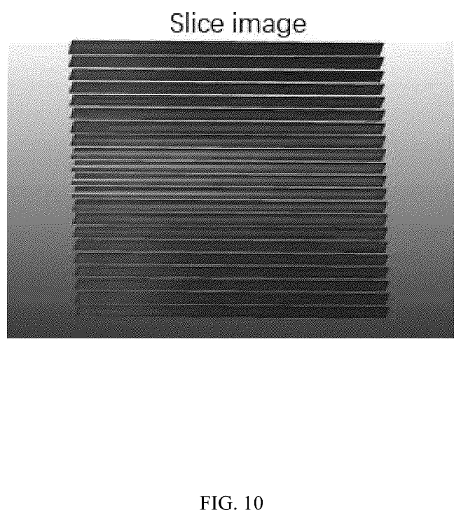

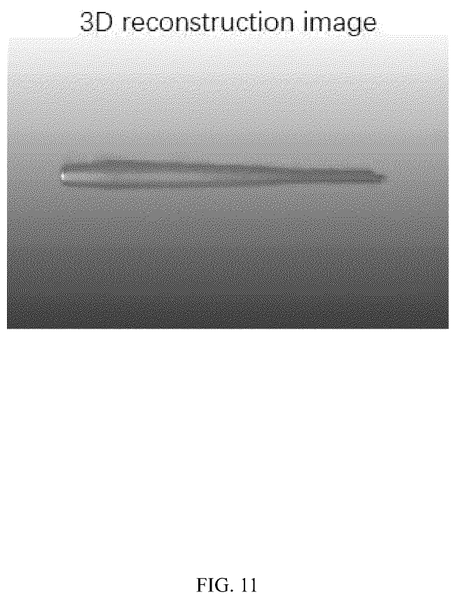

The fluid temperature field tomography visualization device 10 can also detect the longitudinal cross-sectional temperature field distribution of the airflow. Referring to FIG. 6, the fluid is ejected from a nozzle in a pipe, with the airflow direction parallel to the carbon nanotube layer 102. The nozzle contacts one side of the carbon nanotube layer 102. By changing the distance between the carbon nanotube and the central tangential surface of the nozzle in a direction perpendicular to the carbon nanotube layer 102, the temperature field distribution of a plurality of longitudinal cross-sections after the airflow exits the nozzle can be measured. In a specific embodiment, FIG. 7 shows an infrared image obtained when the surface of the carbon nanotube layer 102 is close to the outer surface of the nozzle; FIG. 8 shows an infrared image obtained when the distance between the surface of the carbon nanotube layer 102 and the outer surface of the nozzle is 1.5 mm; FIG. 9 shows an infrared image obtained when the distance between the surface of the carbon nanotube layer 102 and the outer surface of the nozzle is 3 mm. By changing the position of the carbon nanotube layer 102, a plurality of airflow infrared images can be obtained, as shown in FIG. 10. Then, through computer synthesis, a 3D infrared photograph of the airflow can be obtained. Based on the image colors, the cross-sectional temperature distribution of the airflow and the temperature distribution of the entire airflow itself can be obtained, as shown in FIG. 11.

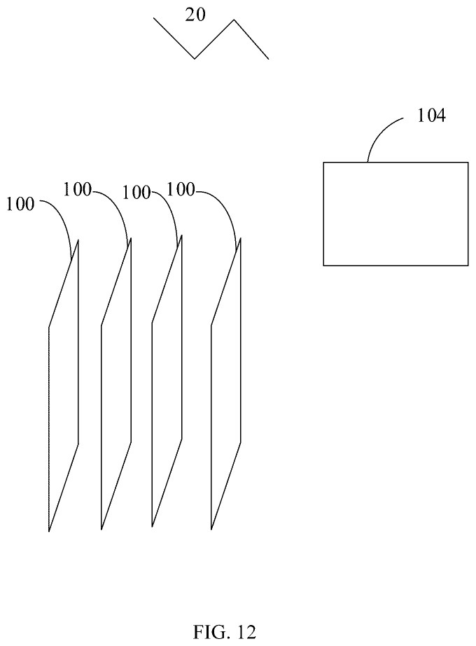

Referring to FIG. 12, a second embodiment of the present disclosure provides a fluid temperature field tomography visualization detection device 20. The fluid temperature field tomography visualization detection device 20 comprises a plurality of planar temperature sensing elements 100, each used to detect the temperature of a fluid cross-section. Each element comprises a suspended carbon nanotube layer (not shown). An infrared thermal imager 104 is spaced apart from the plurality of planar temperature sensing elements 100 and detects the infrared signal of the suspended carbon nanotube layer, creating an image based on this signal.

The plurality of planar temperature sensing elements 100 are arranged side-by-side at intervals on the cross-section of the fluid to be measured. The number of elements is unlimited and can be set according to actual needs. By adjusting the focal length of the infrared thermal imager 104, the temperature field on the fluid cross-section where the plurality of planar temperature sensing elements 100 are located can be obtained. In this embodiment, there are four planar temperature sensing elements 100, with a distance of 1.5 mm between each element.

In addition to the features mentioned above, the fluid temperature field tomography visualization detection device 20 provided in this embodiment has the same structure and properties as the fluid temperature field tomography visualization detection device 10 provided in the first embodiment, and will not be described in detail here.

The fluid temperature field tomography visualization detection device provided by this disclosure utilizes the principle of rapid response of carbon nanotube layers to ambient temperature, which can sensitively detect the temperature of the fluid under test, rapidly heat up or cool down to the same temperature as the cross-section of the fluid under test, thereby radiating infrared signals of different energies, which are then detected and imaged by an infrared thermal imager, realizing the visualization of fluid temperature field tomography. This detection device has a simple structure, is easy to operate, and has a wide range of applications.

It is to be understood that the above-described embodiments are intended to illustrate rather than limit the present disclosure. Variations can be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

Depending on the embodiment, certain of the steps of a method described can be removed, others can be added, and the sequence of steps can be altered. The description and the claims drawn to a method may comprise some indication in reference to certain steps. However, the indication used is only to be viewed for identification purposes and not as a suggestion as to an order for the steps.

What is claimed is:

1. A fluid temperature field tomography visualization detection device, comprising:
a planar temperature sensing element comprising a carbon nanotube layer suspended in the air that is configured for detecting a temperature of a fluid cross-section;
an infrared thermal imager spaced apart from the planar temperature sensing element, wherein the infrared thermal imager is configured to detect an infrared signal of the carbon nanotube layer and an image based on the infrared signal of the carbon nanotube layer.

2. The fluid temperature field tomography visualization detection device of claim 1, further comprising a support, a first electrode, a second electrode, and a power supply.

3. The fluid temperature field tomography visualization detection device of claim 2, wherein the first electrode and the second electrode are disposed at respective ends of the carbon nanotube layer and electrically connected to the carbon nanotube layer, and the power supply provides electric current to the carbon nanotube layer through the first electrode and the second electrode.

4. The fluid temperature field tomography visualization detection device of claim 2, wherein the support is configured to the carbon nanotube layer.

5. The fluid temperature field tomography visualization detection device of claim 1, wherein the carbon nanotube layer is a free-standing structure.

6. The fluid temperature field tomography visualization detection device of claim 1, wherein the carbon nanotube layer comprises at least one carbon nanotube film, the at least one carbon nanotube film comprising a plurality of carbon nanotubes connected by van der Waals forces.

7. The fluid temperature field tomography visualization detection device of claim 1, wherein the carbon nanotube layer comprises at least one super-aligned carbon nanotube film, each of the at least one super-aligned carbon nanotube film comprises a plurality of carbon nanotubes, an extending direction of each of the plurality of carbon nanotubes in a super-aligned carbon nanotube film of the at least one super-aligned carbon nanotube film is substantially same, the plurality of carbon nanotubes in the super-aligned carbon nanotube film is arranged parallel to a surface of the carbon nanotube layer, and an end of a carbon nanotube in the extending direction, of the plurality of carbon nanotubes, is connected an end of another carbon nanotube in the extending direction, of the plurality of carbon nanotubes, by van der Waals forces.

8. The fluid temperature field tomography visualization detection device of claim 7, wherein the carbon nanotube layer comprises two super-aligned carbon nanotube films, the two super-aligned carbon nanotube films are vertically arranged.

9. The fluid temperature field tomography visualization detection device of claim 1, wherein the carbon nanotube layer is a layered structure comprising a plurality of carbon nanotube wires, the plurality of carbon nanotube wires are arranged in parallel to form the carbon nanotube layer.

10. The fluid temperature field tomography visualization detection device of claim 1, wherein the carbon nanotube layer is a layered structure comprising a plurality of carbon nanotube wires, the plurality of carbon nanotube wires are woven together to form the carbon nanotube layer.

11. A fluid temperature field tomography visualization detection device, comprising:
a plurality of planar temperature sensing elements spaced apart from each other, wherein each planar temperature sensing element is configured to detect a temperature of a cross-section of fluid, and each planar temperature sensing element comprising a carbon nanotube layer suspended in the air;
an infrared thermal imager, spaced apart from the plurality of planar temperature sensing elements, wherein the infrared thermal imager is configured to detect an infrared signal of the carbon nanotube layer and to an image based on the suspended infrared signal of the carbon nanotube layer.

12. The fluid temperature field tomography visualization detection device of claim 11, wherein the carbon nanotube layer is a free-standing structure.

13. The fluid temperature field tomography visualization detection device of claim 11, wherein the carbon nanotube layer comprises at least one carbon nanotube film, the at least one carbon nanotube film comprising a plurality of carbon nanotubes connected by van der Waals forces.

14. The fluid temperature field tomography visualization detection device of claim 11, wherein the carbon nanotube film is a super-aligned carbon nanotube film, the super-aligned carbon nanotube film comprises a plurality of carbon nanotubes preferentially oriented in a same direction and arranged parallel to a surface of the super-aligned carbon nanotube film, and the carbon nanotubes are connected end-to-end by van der Waals forces in the extending direction of the carbon nanotubes.

15. The fluid temperature field tomography visualization detection device of claim 14, wherein the carbon nanotube layer comprises two vertically arranged super-aligned carbon nanotube films.

16. The fluid temperature field tomography visualization detection device of claim 1, wherein the carbon nanotube layer is a layered structure comprising a plurality of carbon nanotube wires, the plurality of carbon nanotube wires are arranged in parallel to form the carbon nanotube layer.

17. The fluid temperature field tomography visualization detection device of claim 1, wherein the carbon nanotube layer is a layered structure comprising a plurality of carbon nanotube wires, the plurality of carbon nanotube wires are woven together to form the carbon nanotube layer.
